(19) United States
(12) Patent Application Publication
(10) Pub. No.: US 2018/0285742 A1
(43) Pub. Date: Oct. 4, 2018

(54) LEARNING METHOD, LEARNING APPARATUS, AND STORAGE MEDIUM

(71) Applicant: FUJITSU LIMITED, Kawasaki-shi (JP)

(72) Inventor: Takuya MAKINO, Kawasaki (JP)

(73) Assignee: FUJITSU LIMITED, Kawasaki-shi (JP)

(21) Appl. No.: 15/935,583

(22) Filed: Mar. 26, 2018

(30) Foreign Application Priority Data
Mar. 31, 2017 (JP) 2017-072972

(51) Int. Cl. G06N 5/02; G06F 17/30

(52) U.S. Cl. CPC G06N 5/02; G06F 17/30371; G06F 17/30463

(57) ABSTRACT

A learning method includes acquiring a query or a matching document text to which a label of a correct answer is given; calculating a first score of the matching document text with respect to the query from a first N-dimensional vector of the query and a second N-dimensional vector of the matching document text; acquiring a plurality of candidates of a non-matching document text to which a label of an incorrect answer not matching the query is given; calculating, for each of the plurality of candidates, a second score with respect to the query; selecting, as the non-matching document text, a candidate having a maximum of the second score; determining whether to update the first model and the second model based on comparison of the first score and the second score; and updating the first model and the second model when a result of the determination satisfies a predetermined condition.

### CROSS-REFERENCE TO RELATED APPLICATION

This application is based upon and claims the benefit of priority of the prior Japanese Patent Application No. 2017-72972, filed on Mar. 31, 2017, the entire contents of which are incorporated herein by reference.

### FIELD

The embodiments discussed herein are related to a learning method, a learning apparatus, and a storage medium.

### BACKGROUND

As an example, a technique called ranking for rearranging a search target document text set in descending order of scores between an input query and the search target document text set is utilized for document searches such as Web and Frequently Asked Questions (FAQ).

For improvement of accuracy of the ranking, as an aspect, an obstacle is a situation in which an input query and a keyword of a document text matching the query may not coincide with each other. For example, when a query is “operation of the personal computer is heavy”, which represents that processing of the personal computer is slow, words included in the query are “operation”, “of”, “the personal computer”, and “heavy”. However, the word “operation”, the word “of”, the word “the personal computer”, and the word “heavy” may not to be included in keywords of a document text matching the query. For example, in some case, in a document text matching the query, “when the laptop freezes” is included as a keyword and a word “laptop freezes”, which does not coincide with the words included in the query, is included in the document text.

Therefore, supervised semantic indexing (SSI) is proposed as an example of a technique for improving the accuracy of the ranking. The SSI converts a query and document texts into dense vectors in the same dimension and calculates inner products between the vectors. The inner products are set as scores of the document texts with respect to the query. The document texts may be ranked in descending order of the scores. The SSI is a framework of supervised learning and learns parameters of models for converting the query and the document texts into vectors. For the learning, document texts matching the query and non-matching document texts selected at random are used. As related art, for example, Bai, B., Weston, J., Grangier, D., CoHobert, R., Sadamasa, K., Qi, Y., Chapelle, O., and Weinberger, K. “Supervised Semantic Indexing.” In: Proceedings of the 18th ACM. pp. 187-196. CIKM '09(2009) is disclosed.

However, in the technique discussed above, naturally, there is a limit in a degree of completion of the models.

That is, in the SSI, since the non-matching document texts are selected at random, only document texts with low scores with respect to the query are selected as the non-matching document texts. As a result, a document text simple as a learning sample is likely to be selected as a non-matching document text. When the simple document text is selected as the non-matching document text, an update frequency of the models decreases. As a result, the degree of completion of the models sometimes decreases. In view of the above, it is desirable to reduce the decrease in the degree of completion of the models.

### SUMMARY

According to an aspect of the invention, a learning method executed by a processor included in a learning apparatus, the learning apparatus including a memory, the learning method includes acquiring, from among a plurality of learning samples stored in the memory, a query or a matching document text to which a label of a correct answer matching the query is given; calculating a first score of the matching document text with respect to the query from a first N-dimensional vector of the query obtained by referring to a first model for converting the query into the first N-dimensional vector and a second N-dimensional vector of the matching document text obtained by referring to a second model for converting the matching document text into the second N-dimensional vector; acquiring, from among the plurality of learning samples, a plurality of candidates of a non-matching document text to which a label of an incorrect answer not matching the query is given; calculating, for each of the plurality of candidates, a second score with respect to the query by using the second N-dimensional vector obtained by referring to the second model and the first N-dimensional vector of the query; selecting, among the plurality of candidates, as the non-matching document text, a candidate having a maximum of the second score with respect to the query; determining whether to update the first model and the second model based on comparison of the first score of the matching document text with respect to the query and the second score of the non-matching document text with respect to the query; and updating the first model and the second model when a result of the determination satisfies a predetermined condition.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a functional configuration of a learning apparatus according to a first embodiment;

FIG. 2 is a diagram illustrating an example of vector conversion of a query;

FIG. 3 is a diagram illustrating an example of vector conversion of a document text;

FIG. 4 is a diagram illustrating an example of a calculation example of a score;

FIG. 5 is a diagram illustrating an example of ranking;

FIG. 6 is a diagram illustrating an example of a search method;

FIG. 7 is a diagram illustrating an example of candidates of a non-matching document text d⁻;

FIG. 8 is a diagram illustrating an example of a selection method for a non-matching document text;

FIG. 9 is a diagram illustrating an example of a comparison result of scores;

FIG. 10 is a diagram illustrating an example of a comparison result of scores;

FIG. 11 is a flowchart for explaining a procedure of learning processing according to the first embodiment; and

FIG. 12 is a diagram illustrating a hardware configuration example of a computer that executes learning programs according to the first embodiment and a second embodiment.

### DESCRIPTION OF EMBODIMENTS

A learning program, a learning method, and a learning apparatus according to embodiments are explained below with reference to the accompanying drawings. The embodiments do not limit a disclosed technique. The embodiments may be combined as appropriate in a range in which the combination of the embodiments does not cause contradiction of processing content.

### First Embodiment

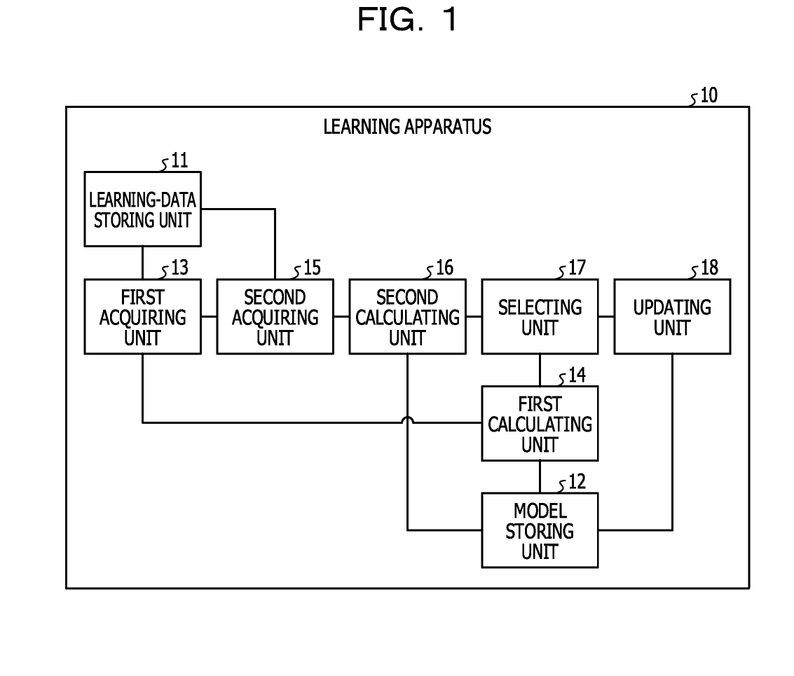

FIG. 1 is a block diagram illustrating a functional configuration of a learning apparatus according to a first embodiment. A learning apparatus 10 illustrated in FIG. 1 realizes learning processing for learning parameters of models for converting a query and a document text into vectors in score calculation of the SSI.

In the SSI, a query and a document text are converted into vectors in the same dimension. In the following explanation, a model used for the vector conversion of a query is sometimes described as “first model” and a model used for the vector conversion of a document text is sometimes described as “second model”.

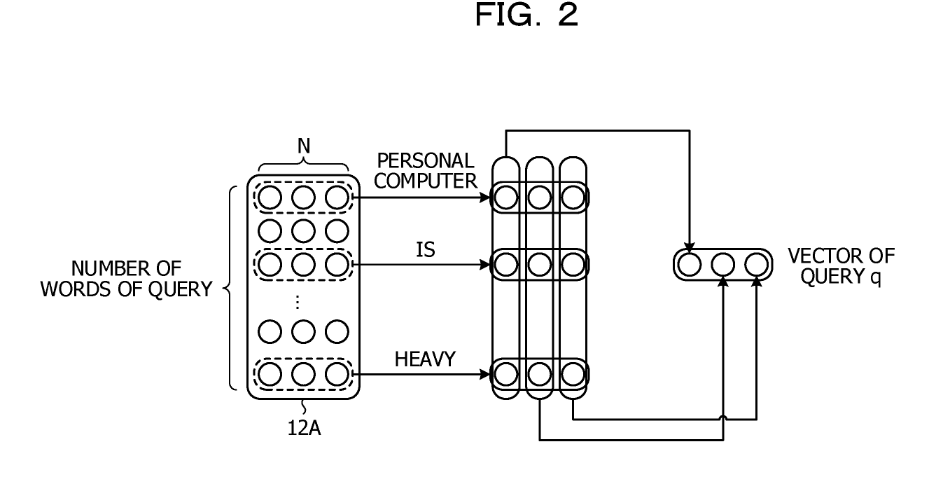

FIG. 2 is a diagram illustrating an example of the vector conversion of a query. As illustrated in FIG. 2, a first model 12A is a N (=3)-dimensional vector with respect to words of the query. Parameters of real number values are retained in elements of the vector. The number of rows of the first model 12A is determined by the number of words appearing in the query used for learning. Any dimension number is set for the number of columns of the first model 12A by a designer or the like of the model. For example, as a larger value is set for N, a computational amount and a memory capacity used for calculation increase. On the other hand, accuracy is improved.

In FIG. 2, as an example, vector conversion performed when an input query is “operation/of/the personal computer/is/heavy” is illustrated. In this case, for each of words included in the query, a vector corresponding to the word is extracted. That is, a three-dimensional row vector corresponding to the word “operation”, a three-dimensional row vector corresponding to the word “of”, a three-dimensional row vector corresponding to the word “the personal computer”, a three-dimensional row vector corresponding to the word “is”, and a three-dimensional row vector corresponding to the word “heavy” are extracted from the first model 12A. A vector of the query may be obtained by calculating an element sum of the five row vectors. That is, a sum of parameters in first columns, a sum of parameters in second columns, and a sum of parameters in third columns of the vector corresponding to the word “operation”, the vector corresponding to the word “of”, the vector corresponding to the word “the personal computer”, the vector corresponding to the word “is”, and the vector corresponding to the word “heavy” are the vector of the query.

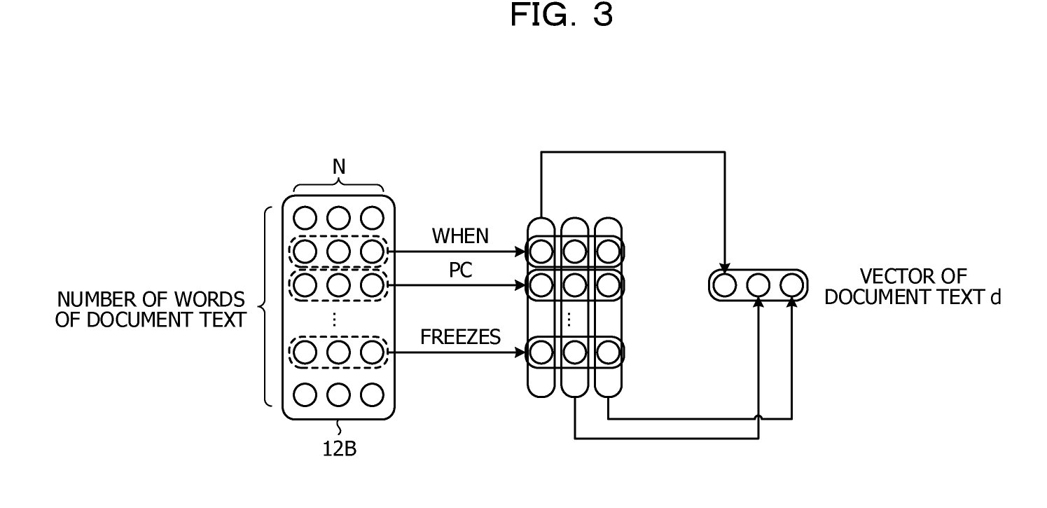

FIG. 3 is a diagram illustrating an example of the vector conversion of a document text. As illustrated in FIG. 3, a second model 12B is an N (=3)-dimensional vector with respect to words of the document text. Parameters of real number values are retained in elements of the vector. The number of rows of the second model 12B is determined by the number of words appearing in the document text used for learning. Any dimension number is set for the number of columns of the second model 12B by a designer or the like of the model. For example, as a larger value is set for N, a computational amount and a memory capacity used for calculation increase. On the other hand, accuracy is improved. The dimension number N of the row vector is common between the first model 12A and the second model 12B.

In FIG. 3, as an example, vector conversion performed when a document text is “when/the PC/freezes”. In this case, for each of words included in the document text, a vector corresponding to the word is extracted. That is, a three-dimensional row vector corresponding to the word “when”, a three-dimensional row vector corresponding to the word “the PC”, and a three-dimensional row vector corresponding to the word “freezes” are extracted from the second model 12B. A vector of the document text may be obtained by calculating an element sum of the three vectors. That is, a sum of parameters in first columns, a sum of parameters in second columns, and a sum of parameters in third columns of the vectors corresponding to the word “when”, the word “the PC”, and the word “freezes” are the vector of the document text.

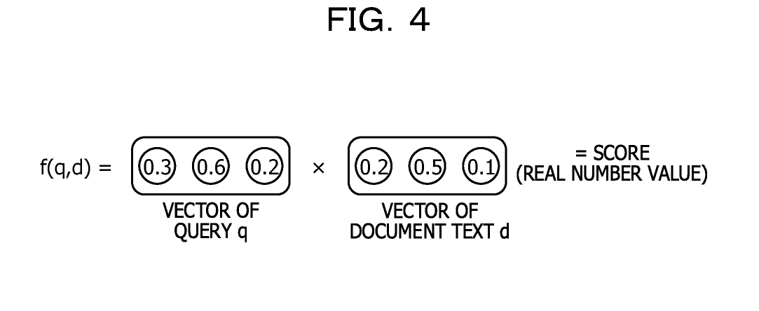

When a vector of a query q and a vector of the document text d are obtained, as an example, a score f(q, d) of the document text d with respect to the query q may be calculated by an inner product of the vector of the query q and the vector of the document text d. FIG. 4 is a diagram illustrating an example of calculation of a score. In FIG. 4, elements of row vectors of the query q are “0.3”, “0.6”, and “0.2” in order from a first column and elements of row vectors of the document text d are “0.2”, “0.5”, and “0.1” in order from a first column. In this case, the score f(q, d) may be calculated as “0.053” according to calculation of [0.3, 0.6, 0.2]×[0.2, 0.5, 0.1]=“0.3×0.2+0.6×0.5+0.2×0.1”.

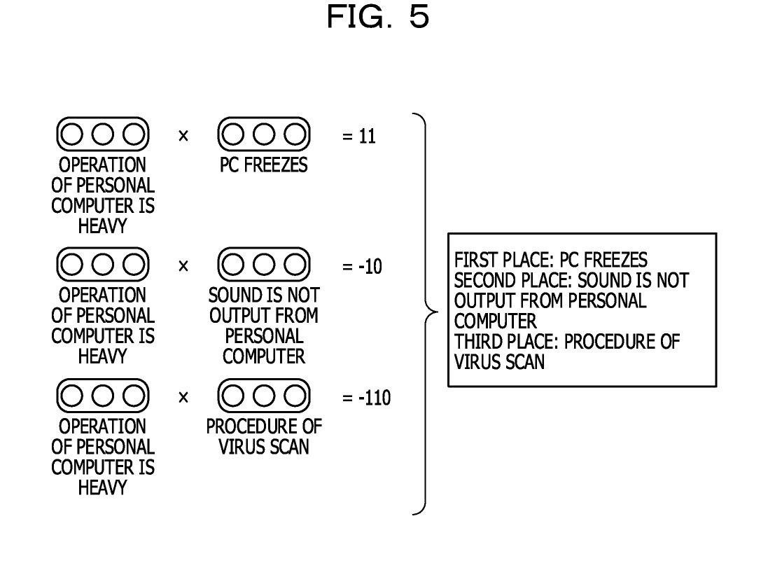

Ranking of document texts may be carried out by arranging the document texts in descending order of scores calculated in this way. FIG. 5 is a diagram illustrating an example of the ranking. On the left side of FIG. 5, a score of a document text “the PC freezes” with respect to a query “operation of the personal computer is heavy”, a score of a document text “sound is not output from the personal computer” with respect to the query “operation of the personal computer is heavy”, and a score of a document text “a procedure of a virus scan” with respect to the query “operation of the personal computer is heavy” are illustrated. In this case, a magnitude relation of the scores is “11>-10>-110”. Therefore, as illustrated on the right side in FIG. 5, the document texts are arranged in the order of the document text “the PC freezes”, the document text “sound is not output from the personal computer”, and the document text “a procedure of a virus scan”.

Under the score calculation explained above, during learning, parameters of the first model 12A and the second model 12B are learned for each of learning samples including queries, matching document texts, and non-matching document texts. The “matching document text” indicates a document text to which a label of a correct answer to the query is given. On the other hand, the “non-matching document text” indicates a document text to which a label of an incorrect answer not matching the query is given.

That is, a vector of the query is derived by, for each of words included in the query of the learning sample, extracting a vector corresponding to the word referring to the first model 12A and then calculating an element sum of vectors of the words. On the other hand, a vector of the matching document text is derived by, for each of words included in the matching document text of the learning sample, extracting a vector corresponding to the word referring to the second model 12B and then calculating an element sum of vectors of the words. A vector of the matching document text is derived by, for each of words included in the non-matching document text of the learning sample, extracting a vector corresponding to the word referring to the second model 12B and then calculating an element sum of vectors of the words.

A score of the matching document text with respect to the query and a score of the non-matching document text with respect to the query are calculated using the vector of the matching document text and the vector of the non-matching document text. The parameters of the first model 12A and the second model 12B are updated on condition that the score of the non-matching document text with respect to the query is larger than the score of the matching document text with respect to the query.

As explained in the section of the background, in the existing SSI, non-matching document texts are selected at random from a set of document texts under the criterion that a document text may be any document text as long as the document text is not a matching document text. Therefore, only document texts with low scores with respect to the query are selected as the non-matching document texts. As a result, a document text simple as a learning sample is likely to be selected as a non-matching document text. When the simple document text is selected as the non-matching document text, an update frequency of the models decreases. As a result, a degree of completion of the models sometimes deceases.

Therefore, the learning apparatus 10 according to this embodiment may not fix a non-matching document text in a learning sample to one document text. For example, the learning apparatus 10 according to this embodiment sets a predetermined number L of document texts as candidates of the non-machining document text, for each of the candidates, calculates scores of the candidates with respect to a query, and then selects a candidate having the largest score as the non-matching document text. Then, according to whether the score of the non-matching document text is larger than a score of a matching document text, the learning apparatus 10 according to this embodiment controls whether to update parameters of the first model 12A and the second model 12B. Consequently, it is possible to reduce the decrease in the update frequency of the models because of the selection of a simple document text as the non-matching document text with respect to the query. Therefore, it is possible to reduce the decrease in the degree of completion of the models.

The learning apparatus 10 illustrated in FIG. 1 is a computer for realizing the learning processing explained above.

As an embodiment, the learning apparatus 10 may be implemented by installing, as package software or online software, in a desired computer, a learning program that executes the learning processing. For example, it is possible to cause the computer to function as the learning apparatus 10 by causing the computer to execute the learning program. The computer is, for example, a desktop or notebook personal computer, a mobile communication terminal such as a smartphone, a cellular phone, or a personal handyphone system (PHS), or a slate terminal such as a personal digital assistance (PDA). A terminal apparatus used by a user may be set as a client. The learning apparatus 10 may be implemented as a server apparatus that provides a service concerning the learning processing to the client. For example, the learning apparatus 10 is implemented as a server apparatus that provides a learning service for receiving an input of learning data including a plurality of learning samples or identification information for enabling the learning data to be invoked via a network or a storage medium and outputting an execution result of the learning processing with respect to the learning data, that is, a learning result of models. In this case, the learning apparatus 10 may be implemented as a Web server or may be implemented as a cloud that provides a service concerning the learning processing through outsourcing.

As illustrated in FIG. 1, the learning apparatus 10 includes a learning-data storing unit 11, a model storing unit 12, a first acquiring unit 13, a first calculating unit 14, a second acquiring unit 15, a second calculating unit 16, a selecting unit 17, and an updating unit 18. The learning apparatus 10 may include various functional units included in a known computer, for example, functional units such as various input devices and sound output devices besides the functional units illustrated in FIG. 1.

The learning-data storing unit 11 is a storing unit that stores learning data. As an example, the learning data includes m learning samples, so-called learning cases. Further, the learning samples include the query q and a matching document text d⁺ to which a label of a correct answer matching the query q is given.

The model storing unit 12 is a storing unit that stores models.

As an embodiment, the first model 12A used for vector conversion of a query and the second model 12B used for vector conversion of a document text are stored in the model storing unit 12. The first model 12A is an N-dimensional vector with respect to words of the query. Parameters of real number values are retained in elements of the vector. A row vector of the first model 12A is generated for each of words appearing in the query included in learning data. The second model 12B is an N-dimensional vector with respect to words of the document text. Parameters of real number values are retained in elements of the vector. A row vector of the second model 12B is generated for each of words appearing in a matching document text and a non-matching document text included in the learning data. The same dimension number is set for the row vectors of the first model 12A and the second model 12B by a designer or the like of the models. For example, as a larger value is set for N, a computational amount and a memory capacity used for calculation increase. On the other hand, accuracy is improved.

The first acquiring unit 13 is a processing unit that acquires a learning sample.

As an embodiment, the first acquiring unit 13 initializes a value of a loop counter i that counts learning samples. The first acquiring unit 13 acquires a learning sample corresponding to the loop counter i among the m learning samples stored in the learning-data storing unit 11. Thereafter, the first acquiring unit 13 increments the loop counter i and repeatedly executes processing for acquiring learning samples from the learning-data storing unit 11 until a value of the loop counter i is equal to a total number m of the learning samples.

The first calculating unit 14 is a processing unit that calculates a score of a matching document text with respect to a query.

As an embodiment, the first calculating unit 14 calculates a score f(q, d⁺) of the matching document text d⁺ with respect to an i-th query q, a learning sample of which is acquired by the first acquiring unit 13. For example, the first calculating unit 14 refers to the first model 12A stored in the model storing unit 12. The first calculating unit 14 derives a vector of the query q by, for each of words included in a query of the learning sample, extracting a vector corresponding to the word and then calculating an element sum of vectors of the words. Further, the first calculating unit 14 refers to the second model 12B stored in the model storing unit 12. The first calculating unit 14 derives a vector of the matching document text d⁺ by, for each of words included in the matching document text d⁺ of the learning sample, extracting a vector corresponding to the word and then calculating an element sum of vectors of the words. Then, the first calculating unit 14 calculates the score f(q, d⁺) of the matching document text d⁺ with respect to the i-th query q by calculating an inner product of the vector of the query q and the vector of the matching document text d⁺.

The second acquiring unit 15 is a processing unit that acquires a plurality of candidates of a non-matching document text corresponding to a query.

As an embodiment, the second acquiring unit 15 receives a word included in the i-th query q, the learning sample of which is acquired by the first acquiring unit 13, and performs ranking based on a degree of coincidence of keywords. Consequently, the second acquiring unit 15 may be able to acquire a higher-order predetermined number L of document texts from a ranking result as candidates c₁ to c_{L} of a non-matching document text.

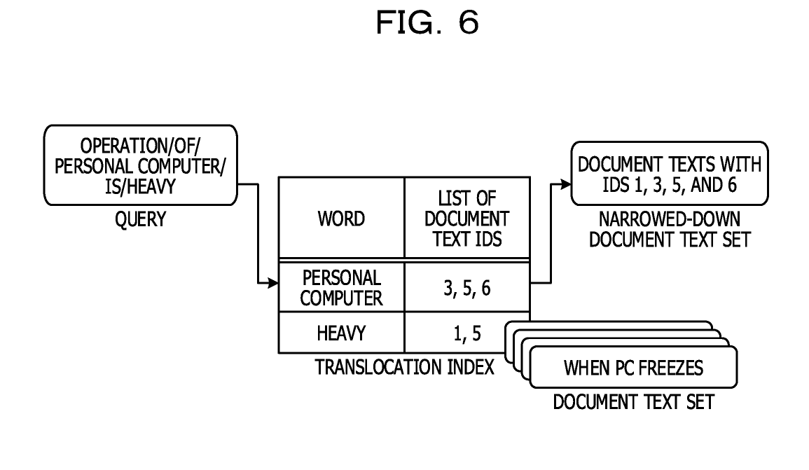

For example, by using a translocation index, which is an index data for search, created from a predetermined document text set, the second acquiring unit 15 may be able to increase speed of search through a document text set in which words included in the i-th query q appear. FIG. 6 is a diagram illustrating an example of a search method. In FIG. 6, a translocation index corresponding to the query q “operation/of/the personal computer/is/heavy” is excerpted and illustrated. However, actually, a translocation index of a document text set as a search target by the second acquiring unit 15 is generated. As illustrated in FIG. 6, the translocation index is data in which, for each of headwords used as indexes, a document text ID (IDentifier) including the headword is associated with a text in a document text. When such a translocation index is used, the second acquiring unit 15 may be able to retrieve, from the search target document text set, document texts with document text IDs “1”, “3”, “5”, and “6” in which the word “personal computer” or the word “heavy” included in the i-th query q appears.

After the document texts in which the word included in the i-th query q appears are retrieved in this way, the second acquiring unit 15 ranks, with any method, a document text set obtained as a search result. As an example, the second acquiring unit 15 performs the ranking by rearranging the document text set obtained as the search result in descending order of tfidf values of a set of words included in a query. For example, when the sets of words included in the query is represented as q and a set of words included in the document text is represented as d, tfidf(q, d) may be calculated according to the following Expression (1). An appearance frequency “tf(d, wᵢ)” of a word in the following Expression (1) may be calculated according to the following Expression (2). An inverse document text frequency “idf(wᵢ, D) in the following Expression (1) may be calculated according to the following Expression (3). In the following Expression (2), “cnt(d, w)” represents the number of times of appearance of w in the set d. In the following Expression (3), “df(w)” represents the number of document texts in which w appears in a set D of document texts set as a search target.

$$\begin{matrix}tfidf ( q , d ) = {\sum }_{{w}_{i} ∈ d ⋂ q} tf ( d , {w}_{i} ) \cdot idf ( {w}_{i} , D ) & ( 1 ) \\ tf ( d , {w}_{i} ) = \frac{cnt ( d , {w}_{i} )}{{\sum }_{{w}_{j} ∈ d} cnt ( d , {w}_{j} )} & ( 2 ) \\ idf ( {w}_{i} , D ) = log \frac{\vert D \vert}{df ( {w}_{i} )} + 1 & ( 3 )\end{matrix}$$

As a frequency of appearance in a document text is higher and a frequency of appearance in other document texts is lower, tfidf(q, d) calculated by the above Expression (1) is a higher value. Therefore, a low tfidf value is calculated for a word appearing in any document text such as “is”. Therefore, even if the word coincides with a keyword in the document text, contribution to ranking is low.

Thereafter, in a ranking result obtained by rearranging the document text set obtained as the search result in descending order of tfidf values, the second acquiring unit 15 acquires a higher-order predetermined number L of document texts as candidates of a non-matching document text d⁻. The same document texts as the matching document text d⁺ are excluded from the higher-order predetermined number L of document texts acquired in this way.

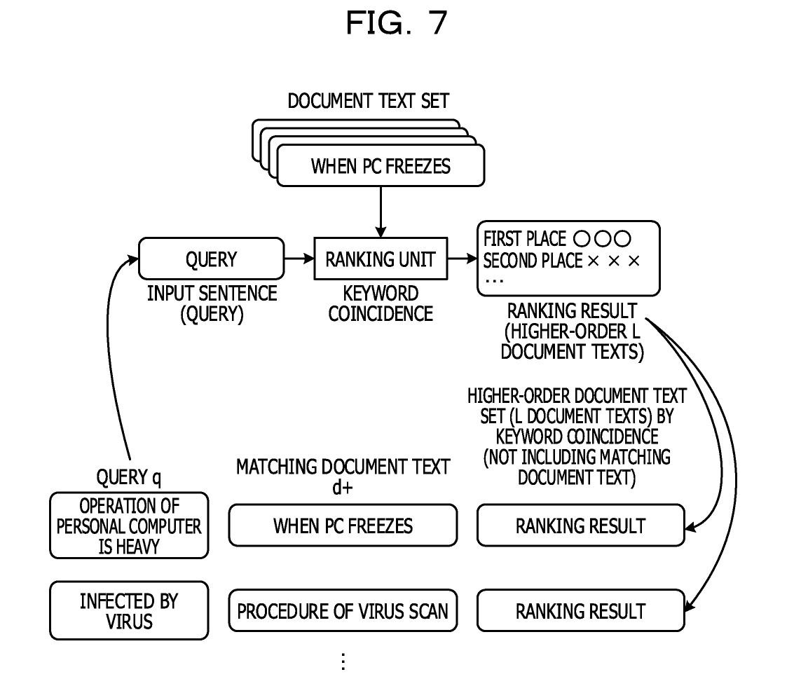

FIG. 7 is a diagram illustrating an example of the candidates of the non-matching document text d⁻. As illustrated in FIG. 7, a document text set in which words included in the query q is searched. Among ranking results obtained by ranking a document text set obtained as a search result, higher-order L ranking results are acquired as the candidates of the non-matching document text d⁻. The query q, the matching document text d⁺, and the higher-order L ranking results are used for learning of parameters of the first model and the second model as one learning sample. As illustrated in FIG. 7, in a query “operation of the personal computer is heavy”, among ranking results obtained by ranking a document text set in which words included in the query appear, higher-order L ranking results are acquired as the candidates of the non-matching document text d⁻. In a query “infected by a virus”, among ranking results obtained by ranking a document text set in which words included in the query appear, higher-order L ranking results are acquired as the candidates of the non-matching document text d⁻. Among the learning samples stored in the learning-data storing unit 11, the candidates of the non-matching document text d⁻ acquired in this way may be registered in association with the query q. Consequently, during second and subsequent learning times, the first acquiring unit 13 acquires the query q, the matching document text d⁺, and the candidates of the non-matching document text d⁻ as learning samples. Therefore, it is possible to omit processing of the second acquiring unit 15 during the second and subsequent learning times.

The second calculating unit 16 is a processing unit that calculates, for each of candidates of a non-matching document text, a score of the candidate with respect to a query.

As an embodiment, the second calculating unit 16 calculates, for each of the candidates c₁ to c_{L} of the non-matching document text d⁻ acquired by the second acquiring unit 15, a score f(qᵢ, cᵢ) of a j-th candidate cj with respect to an i-th query q, a learning sample of which is acquired by the first acquiring unit 13. For example, the second calculating unit 16 refers to the first model 12A stored in the model storing unit 12. The second calculating unit 16 derives a vector of the query q by, for each of words included in a query of the learning sample, extracting a vector corresponding to the word and then calculating an element sum of vectors of the words. Further, the second calculating unit 16 refers to the second model 12B stored in the model storing unit 12. The second calculating unit 16 derives a vector of the candidate of the j-th non-matching document text d⁻ by, for each of words included in the candidate of the j-th non-matching document text d⁻ in the higher-order L ranking results c₁ to c_{L}, extracting a vector corresponding to the word and then calculating an element sum of vectors of the words. Then, the second calculating unit 16 calculates the score f(qᵢ, cⱼ) of the candidate of the j-th non-matching document text d⁻ with respect to the i-th query q by calculating an inner product of the vector of the query q and the vector of the candidate of the j-th non-matching document text d⁻. By updating a variable j for counting the candidate to 1 to L, the second calculating unit 16 calculates scores f(qᵢ, c₁) to f(qᵢ, c_{L}) of the candidates c₁ to c_{L} with respect to the query q.

The selecting unit 17 is a processing unit that selects a non-matching document text out of candidates of the non-matching document texts.

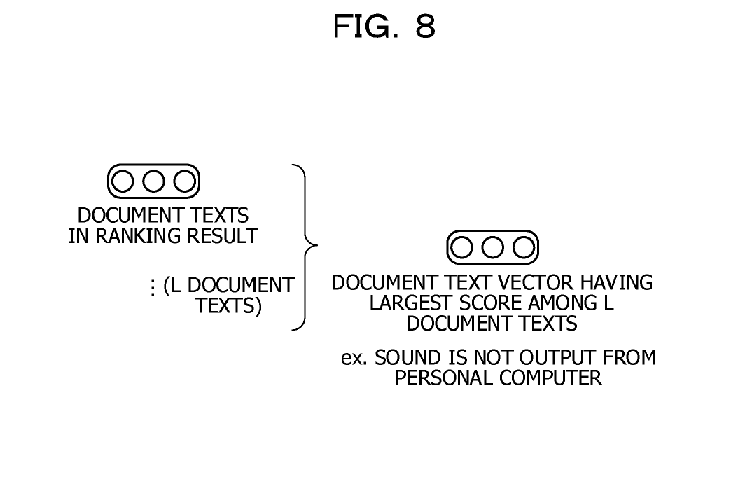

As an embodiment, the selecting unit 17 selects, as the non-matching document text d⁻, a candidate of the non-matching document text having a maximum value among the scores f(qᵢ, c₁) to f(qᵢ, c_{L}) calculated for each of the candidates of the non-matching document text by the second calculating unit 16. FIG. 8 is a diagram illustrating an example of a selection method for a non-matching document text. As illustrated in FIG. 8, the selecting unit 17 selects, as the non-matching document text d⁻, a candidate of the non-matching document text for which a score of a maximum value is calculated by the second calculating unit 16 among the L candidates of the non-matching document text acquired by the second acquiring unit 15. In the example illustrated in FIG. 8, a document text “sound is not output from the personal computer” is selected as the non-matching document text d⁻ out of the L candidates of the non-matching document text.

The updating unit 18 is a processing unit that performs update of models.

As an embodiment, the updating unit 18 compares the score f(q, d⁺) of the matching document text d⁺ with respect to the i-th query q calculated by the first calculating unit 14 and the score f(q, d⁻) of the non-matching document text d⁻ with respect to the i-th query q selected by the selecting unit 17. Consequently, the updating unit 18 controls whether to update the first model 12A and the second model 12B stored in the model storing unit 12.

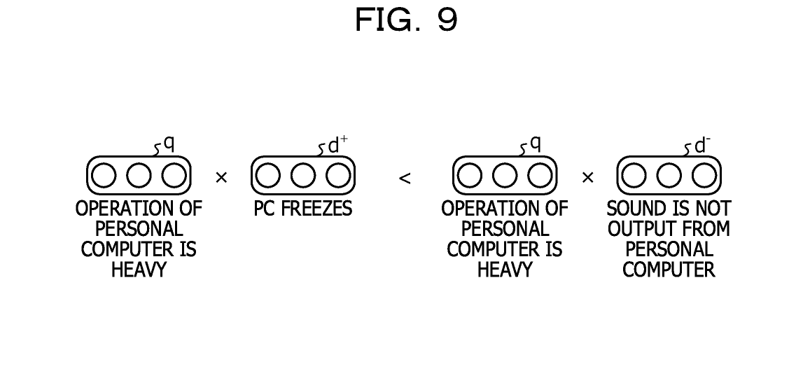

FIG. 9 is a diagram illustrating an example of a comparison result of scores. In FIG. 9, an example is illustrated in which the query q is “operation of the personal computer is heavy”, the matching document text d⁺ is “the PC freezes”, and the non-matching document text d⁻ is “sound is not output from the personal computer”. As illustrated in FIG. 9, when the score f(q, d⁺) of the matching document text d⁺ with respect to the query q is smaller than the score f(q, d⁻) of the non-matching document text d⁻ with respect to the i-th query q, the updating unit 18 updates parameters U of the first model 12A and parameters V of the second model 12B stored in the model storing unit 12. For example, the updating unit 18 updates the parameters U of the first model 12A using the following Expression (4). The updating unit 18 updates the parameters V of the second model 12B using the following Expression (5). “λ” in the following Expression (4) and the following Expression (5) indicates a learning ratio. That is, according to the following Expression (4), a value is added to a parameter of a word of a query corresponding to a word of a matching document text among the parameters U of the first model 12A. A value is subtracted from a parameter of a word of a query corresponding to a word of a non-matching document text. Similarly, according to the following Expression (5), a value is added to a parameter of a word of a matching document text corresponding to a word of a query among the parameters V of the second model 12B. A value is subtracted from a parameter of a word of a non-matching document text corresponding to the word of the query.

U=U+λV(d₍ᵢ₎⁺−d₍ᵢ₎⁻)q₍ᵢ₎^{T} (4)

V=V+λUq₍ᵢ₎(d₍ᵢ₎⁺−d₍ᵢ₎⁻)^{T} (5)

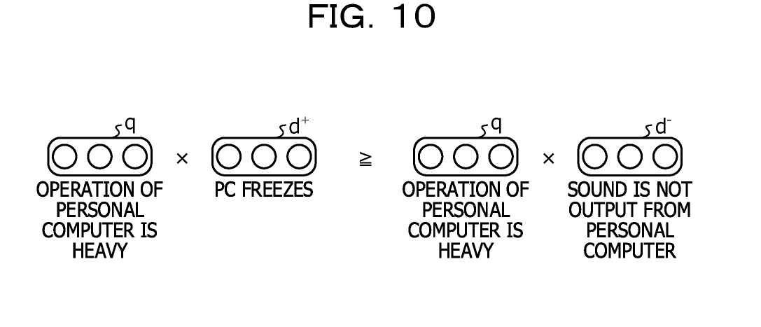

FIG. 10 is a diagram illustrating an example of a comparison result of scores. In FIG. 10, as in FIG. 9, an example is illustrated in which the query q is “operation of the personal computer is heavy”, the matching document text d⁺ is “the PC freezes”, and the non-matching document text d⁻ is “sound is not output from the personal computer”. As illustrated in FIG. 10, when the score f(q, d⁺) of the matching document text d⁺ with respect to the query q is equal to or larger than the score f(q, d) of the non-matching document text d⁻ with respect to the i-th query q, the updating unit 18 does not update the parameters U of the first model 12A and the parameters V of the second model 12B stored in the model storing unit 12.

The first model and the second model obtained as a learning result of such parameters may be applied as well when a document text set set as a search target is ranked. However, the first model and the second model are more suitably applied when a document text set narrowed down to higher-order L document texts by ranking based on a degree of coincidence of keywords is re-ranked.

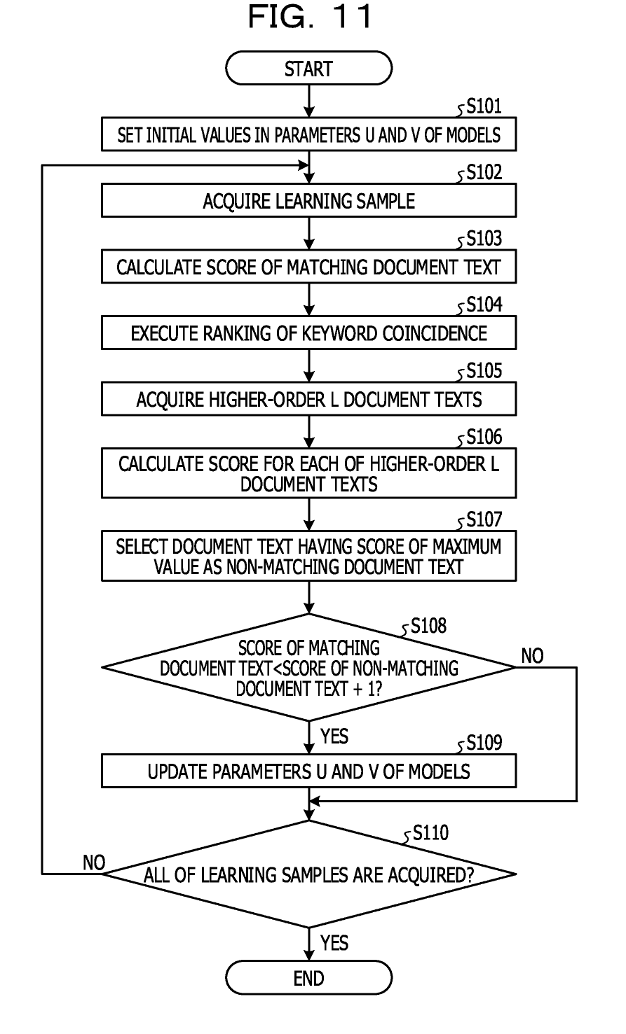

FIG. 11 is a flowchart for explaining a procedure of learning processing according to the first embodiment. As an example, the processing is executed when a start instruction of learning is received. As illustrated in FIG. 11, the updating unit 18 sets initial values in the parameters U of the first model 12A and the parameters V of the second model 12B stored in the model storing unit 12 (S101). For example, the updating unit 18 gives the initial values to the parameters U and the parameters V by generating a random number in a range of a normal distribution of an average “0” and a standard deviation “1”.

Subsequently, the first acquiring unit 13 initializes a value of the loop counter i, which counts learning samples, to “1” and acquires an i-th learning sample among the m learning samples stored in the learning-data storing unit 11 (S102).

The first calculating unit 14 calculates the core f(q, d⁺) of the matching document text d⁺ with respect to the i-th query q from an N-dimensional vector of the i-th query q derived by, for each of words included in the i-th query q, calculating an element sum of the N-dimensional vector extracted from the first model 12A and an N-dimensional vector of the matching document text d⁺ derived by, for each of words included in the matching document text d⁺, calculating an element sum of the N-dimensional vector extracted from the second model 12B (S103).

The second acquiring unit 15 receives an input of a word included in the i-th learning sample acquired in S102 and performs ranking based on a degree of coincidence of keywords (S104). From a ranking result obtained as a result of S104, the second acquiring unit 15 acquires a higher-order predetermined number L of document texts as the candidates c₁ to c_{L} of the non-matching document text d⁻(S105).

Subsequently, the second calculating unit 16 calculates the scores f(qᵢ, c₁) to f(qᵢ, c_{L}) of the candidates c₁ to c_{L} of the non-matching document text d⁻ with respect to the i-th query q according to the first model 12A and the second model 12B (S106).

The selecting unit 17 selects, as the non-matching document text d⁻, a candidate of a non-matching document text for which a score of a maximum value is calculated in S106 among the higher-order L candidates of the non-matching document text acquired in S105 (S107).

Thereafter, the updating unit 18 determines whether the score f(q, d⁺) of the matching document text d⁺ with respect to the i-th query q calculated in S103 is smaller than a value obtained by adding a predetermined value, for example, “1” to the score f(q, d⁻) of the non-matching document text d⁻ with respect to the i-th query q selected on S107, that is, whether f(q, d⁺)<f(q, d⁻)+1 is satisfied (S108).

When f(q, d⁺)<f(q, d⁻)+1 is satisfied (Yes in S108), the updating unit 18 updates the parameters U of the first model 12A and the parameters V of the second model 12B stored in the model storing unit 12 (S109). On the other hand, when f(q, d⁺)<f(q, d⁻)+1 is not satisfied (No in S108), processing in S109 is skipped.

Until all learning samples are acquired, in other words, when the loop counter i is not equal to m (No in S110), the updating unit 18 increments the loop counter i by 1 and repeatedly executes the processing in S102 to S109. Thereafter, when all the learning samples are acquired, in other words, when the loop counter i is equal to m (Yes in S110), the updating unit 18 ends the processing.

In the flowchart of FIG. 11, the processing in S103 to S107 is executed in the order of the step numbers. However, the processing in S103 and the processing in S104 to S107 may be executed in parallel or may be executed in random order.

In the flowchart of FIG. 11, the processing is ended when all the learning samples included in the learning data are learned. However, the processing in S102 to S109 may be further looped until predetermined accuracy is obtained by the first model and the second model.

As explained above, the learning apparatus 10 according to this embodiment calculates, for each of the candidates of the predetermined number L of non-matching document texts, a score of the candidate with respect to the query and then selects a candidate having the largest score as the non-matching document text. Then, according to whether a score of the non-matching document text is larger than a score of the matching document text, the learning apparatus 10 according to this embodiment controls whether to update the parameters of the first model 12A and the second model 12B. Consequently, it is possible to reduce the decrease in the update frequency of the models because of the selection of a simple document text as the non-matching document text with respect to the query. Therefore, with the learning apparatus 10 according to this embodiment, it is possible to reduce the decrease in the degree of completion of the models.

The first model and the second model obtained as a learning result of such parameters may be able to realize highly accurate ranking when a document text set narrowed down to higher-order L document texts by ranking based on a degree of coincidence of keywords is re-ranked besides when a document text set as a search target is ranked.

### Second Embodiment

The embodiment concerning the disclosed apparatus is explained above. However, the present disclosure may be carried out in various different forms other than the embodiment explained above. Therefore, in the following explanation, other embodiments included in the present disclosure are explained.

The components of the devices illustrated in the figures do not have to be physically configured as illustrated in the figures. That is, specific forms of dispersion and integration of the devices are not limited to the forms illustrated in the figures. All or a part of the devices may be functionally or physically dispersed or integrated in any units according to various loads, states of use, and the like. For example, the first acquiring unit 13, the first calculating unit 14, the second acquiring unit 15, the second calculating unit 16, the selecting unit 17, and the updating unit 18 may be connected through a network as external devices of the learning apparatus 10. Different apparatuses may respectively include the first acquiring unit 13, the first calculating unit 14, the second acquiring unit 15, the second calculating unit 16, the selecting unit 17, and the updating unit 18. The apparatuses may be connected by the network and cooperate to realize the functions of the learning apparatus 10. Different apparatuses may respectively include all or a part of the information stored in the learning-data storing unit 11 or the model storing unit 12. The apparatuses may be connected by the network and cooperate to realize the functions of the learning apparatus 10.

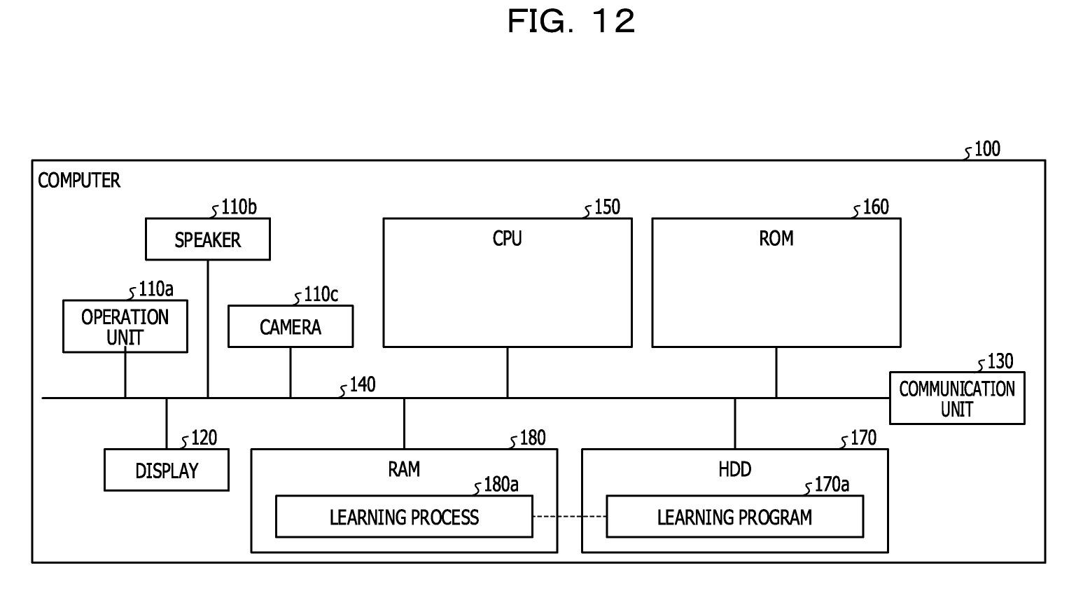

The various kinds of processing explained in the embodiment may be realized by a computer such as a personal computer or a work station executing computer programs prepared in advance. Therefore, in the following explanation, an example of a computer that executes a learning program having the same functions as the functions in the embodiment is explained with reference to FIG. 12.

FIG. 12 is a diagram illustrating a hardware configuration example of a computer that executes learning programs according to the first embodiment and the second embodiment. As illustrated in FIG. 12, a computer 100 includes an operation unit 110a, a speaker 110b, a camera 110c, a display 120, and a communication unit 130. Further, the computer 100 includes a CPU 150, a ROM 160, a HDD 170, and a RAM 180. These unit 110a and 110b to 180 are connected via a bus 140.

In the HDD 170, as illustrated in FIG. 12, a learning program 170a that exhibits the same functions as the first acquiring unit 13, the first calculating unit 14, the second acquiring unit 15, the second calculating unit 16, the selecting unit 17, and the update unit 18 explained in the first embodiment is stored. Like the first acquiring unit 13, the first calculating unit 14, the second acquiring unit 15, the second calculating unit 16, the selecting unit 17, and the updating unit 18 illustrated in FIG. 1, the learning program 170a may be integrated or separated. That is, not all of the data explained in the first embodiment have to be stored in the HDD 170. Data used for the processing only has to be stored in the HDD 170.

Under such an environment, the CPU 150 reads out the learning program 170a from the HDD 170 and develops the learning program 170a on the RAM 180. As a result, as illustrated in FIG. 12, the learning program 170a functions as a learning process 180a. The learning process 180a develops various data read out from the HDD 170 in a region allocated to the learning process 180a in a storage region of the RAM 180 and executes various kinds of processing using the developed various data. As an example of the processing executed by the learning process 180a, for example, the processing illustrated in FIG. 11 is included. In the CPU 150, not all of the processing units explained in the first embodiment have to operate. A processing unit corresponding to execution target processing only has to be virtually realized.

The learning program 170a may not to be stored in the HDD 170 and the ROM 160 from the beginning. For example, the learning program 170a is stored in a “portable physical medium” such as a flexible disk, a so-called FD, a CD-ROM, a DVD disk, a magneto-optical disk, or an IC card inserted into the computer 100. The computer 100 may acquire the learning program 170a from the portable physical medium and execute the learning program 170a. The learning program 170a may be stored in another computer, a server apparatus, or the like connected to the computer 100 via a public line, the Internet, a LAN, a WAN, or the like. The computer 100 may acquire the learning program 170a from the other computer or the server apparatus and execute the learning program 170a.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A learning method executed by a processor included in a learning apparatus, the learning apparatus including a memory, the learning method comprising:
acquiring, from among a plurality of learning samples stored in the memory, a query or a matching document text to which a label of a correct answer matching the query is given;
calculating a first score of the matching document text with respect to the query from a first N-dimensional vector of the query obtained by referring to a first model for converting the query into the first N-dimensional vector and a second N-dimensional vector of the matching document text obtained by referring to a second model for converting the matching document text into the second N-dimensional vector;
acquiring, from among the plurality of learning samples, a plurality of candidates of a non-matching document text to which a label of an incorrect answer not matching the query is given;
calculating, for each of the plurality of candidates, a second score with respect to the query by using the second N-dimensional vector obtained by referring to the second model and the first N-dimensional vector of the query;
selecting, among the plurality of candidates, as the non-matching document text, a candidate having a maximum of the second score with respect to the query;
determining whether to update the first model and the second model based on comparison of the first score of the matching document text with respect to the query and the second score of the non-matching document text with respect to the query; and
updating the first model and the second model when a result of the determination satisfies a predetermined condition.

2. The learning method according to claim 1, wherein the acquiring a plurality of candidates of the non-matching document text includes:
executing ranking based on a degree of coincidence of keywords between a word included in the query and a word included in a predetermined document text set; and
acquiring, from a result of the ranking, a higher-order predetermined number of the plurality of document texts as the plurality of candidates of the non-matching document text.

3. The learning method according to claim 1, wherein
the determining includes determining whether the first score of the matching document text is smaller than the second score of the non-matching document text, and
the updating includes updating the first model and the second model when it is determined that the first score of the matching document text is smaller than the second score of the non-matching document text.

4. The learning method according to claim 1, wherein
the first N-dimensional vector of the query is acquired by calculating an element sum of the first N-dimensional vector extracted from the first model for each of a plurality of words included in the query; and
the second N-dimensional vector of the matching document text is acquired by calculating an element sum of the second N-dimensional vector extracted from the second model for each of a plurality of words included in the matching document text.

5. The learning method according to claim 1,
wherein the learning method is repeated until the learning method is executed on all of the plurality of learning samples.

6. The learning method according to claim 1,
wherein the learning method is repeated until predetermined accuracy is obtained by the first model and the second model.

7. A learning apparatus comprising:
a memory; and
a processor coupled to the memory and configured to:
acquiring, from among a plurality of learning samples stored in the memory, a query or a matching document text to which a label of a correct answer matching the query is given,
calculate a first score of the matching document text with respect to the query from a first N-dimensional vector of the query obtained by referring to a first model for converting the query into the first N-dimensional vector and a second N-dimensional vector of the matching document text obtained by referring to a second model for converting the matching document text into the second N-dimensional vector,
acquire, from among the plurality of learning samples, a plurality of candidates of a non-matching document text to which a label of an incorrect answer not matching the query is given,
calculate, for each of the plurality of candidates, a second score with respect to the query by using the second N-dimensional vector obtained by referring to the second model and the first N-dimensional vector of the query,
select, among the plurality of candidates, as the non-matching document text, a candidate having a maximum of the second score with respect to the query,
determine whether to update the first model and the second model based on comparison of the first score of the matching document text with respect to the query and the second score of the non-matching document text with respect to the query, and
update the first model and the second model when a result of the determination satisfies a predetermined condition.

8. The learning apparatus according to claim 7, wherein the processor is configured to:
execute ranking based on a degree of coincidence of keywords between a word included in the query and a word included in a predetermined document text set, and
acquire, from a result of the ranking, a higher-order predetermined number of the plurality of document texts as the plurality of candidates of the non-matching document text.

9. The learning apparatus according to claim 7, wherein the processor is configured to:
determine whether the score of the matching document text is smaller than the score of the non-matching document text, and
update the first model and the second model when it is determined that the score of the matching document text is smaller than the score of the non-matching document text.

10. The learning apparatus according to claim 7, wherein
the N-dimensional vector of the query is acquired by calculating an element sum of the N-dimensional vector extracted from the first model for each of a plurality of words included in the query, and
the N-dimensional vector of the matching document text is acquired by calculating an element sum of the N-dimensional vector extracted from the second model for each of a plurality of words included in the matching document text.

11. The learning apparatus according to claim 7,
wherein the learning method is repeated until the learning method is executed on all of the plurality of learning samples.

12. The learning apparatus according to claim 7,
wherein the learning method is repeated until predetermined accuracy is obtained by the first model and the second model.

13. A non-transitory computer-readable storage medium storing a program that causes a processor included in a learning apparatus to execute a process, the learning apparatus including a memory, the process comprising:
acquiring, from among a plurality of learning samples stored in the memory, a query or a matching document text to which a label of a correct answer matching the query is given;
calculating a first score of the matching document text with respect to the query from a first N-dimensional vector of the query obtained by referring to a first model for converting the query into the first N-dimensional vector and a second N-dimensional vector of the matching document text obtained by referring to a second model for converting the matching document text into the second N-dimensional vector;
acquiring, from among the plurality of learning samples, a plurality of candidates of a non-matching document text to which a label of an incorrect answer not matching the query is given;
calculating, for each of the plurality of candidates, a second score with respect to the query by using the second N-dimensional vector obtained by referring to the second model and the first N-dimensional vector of the query;
selecting, among the plurality of candidates, as the non-matching document text, a candidate having a maximum of the second score with respect to the query;
determining whether to update the first model and the second model based on comparison of the first score of the matching document text with respect to the query and the second score of the non-matching document text with respect to the query; and
updating the first model and the second model when a result of the determination satisfies a predetermined condition.
